(19) United States
(12) Patent Application Publication
(10) Pub. No.: US 2013/0227255 A1
(43) Pub. Date: Aug. 29, 2013

(54) RECONFIGURABLE PROCESSOR, CODE CONVERSION APPARATUS THEREOF, AND CODE CONVERSION METHOD

(71) Applicant: Chang-Moo KIM, Seoul (KR)

(72) Inventor: Chang-Moo KIM, Seoul (KR)

(73) Assignee: Samsung Electronics Co., Ltd., Suwon-si (KR)

(21) Appl. No.: 13/779,961

(22) Filed: Feb. 28, 2013

(30) Foreign Application Priority Data
Feb. 28, 2012 (KR) 10-2012-0020560

(51) Int. Cl. G06F 9/30

(52) U.S. Cl. CPC G06F 9/30076
USPC 712/229

(57) ABSTRACT

A reconfigurable processor, a code conversion apparatus thereof, and a code conversion method are provided. The reconfigurable processor includes a processor including functional units (FUs) and execution modes, the execution modes including a Very Long Instruction Word (VLIW) mode based on a first FU group, a first Coarse-Grained Array (CGA) mode based on FUs of a second FU group, and a second CGA mode based on predetermined ones of the FUs of the second FU group.

### CROSS-REFERENCE TO RELATED APPLICATIONS

This application claims the benefit under 35 U.S.C. §119(a) of a Korean Patent Application No. 10-2012-0020560, filed on Feb. 28, 2012, the entire disclosure of which is incorporated herein by reference for all purposes.

### BACKGROUND

1. Field

The following description relates to a reconfigurable processor, a code conversion apparatus thereof, and a code conversion method.

2. Description of the Related Art

Hardware typically has fixed functionality. As a result, it is difficult to use only hardware to efficiently handle modifications or changes made when processing tasks. In addition, while software easily accommodates modifications or changes during task processing, processing tasks using only software results in a lower processing speed than does processing tasks using only hardware.

A reconfigurable architecture is able to change configuration of hardware in a computing apparatus to optimize the hardware for a specific task. The reconfigurable architecture can be designed to acquire all advantages of processing tasks via hardware or software. As a result, the reconfigurable architecture has attracted a lot of attention in a digital signal processing field in which the same tasks are iteratively executed.

A representative reconfigurable architecture is a Coarse-Grained Array (CGA). The CGA includes processing units and can be optimized for a specific task by changing connections between the processing units. Meanwhile, a reconfigurable architecture has been introduced in which a specific processing unit of a CGA is utilized as a Very Long Instruction Word (VLIW) machine. Such a reconfigurable architecture has two execution modes. Generally, a reconfigurable architecture having a CGA mode and a VLIW mode processes, in the CGA mode, loops in which the same operations are iteratively executed and, in the VLIW mode, general operations except for such loop operations.

### SUMMARY

In one general aspect, a reconfigurable processor includes a processor including functional units (FUs) and execution modes, the execution modes including a Very Long Instruction Word (VLIW) mode based on a first FU group, a first Coarse-Grained Array (CGA) mode based on FUs of a second FU group, and a second CGA mode based on predetermined ones of the FUs of the second FU group.

The reconfigurable processor may further include a configuration memory configured to store configuration information for the VLIW mode, the first CGA mode, and the second CGA mode, and a decoder configured to receive a predetermined mode conversion signal, select/convert a piece of the configuration information stored in the configuration memory according to the predetermined mode conversion signal, and transfer the selected/converted configuration information to the processor.

The reconfigurable processor may further include that the configuration memory stores first CGA configuration information for the first CGA mode and second CGA configuration information for the second CGA mode, in different memory areas.

The reconfigurable processor may further include that the second CGA configuration information has a capacity that is less than a capacity of the first CGA configuration information.

The reconfigurable processor may further include that the decoder is further configured to, in the first CGA mode, transfer the first CGA configuration information to the processor and, in the second CGA mode, convert the second CGA configuration information and transfer the converted CGA configuration information to the processor.

The reconfigurable processor may further include that the decoder is further configured to convert configuration information of the second CGA configuration information not mapped to the predetermined ones of the FUs of the second FU group into a predetermined value.

The reconfigurable processor may further include a power supply configured to power off one or more FUs that do not operate in a current mode.

The reconfigurable processor may further include that mode conversion between the first CGA mode and the second CGA mode is performed through the VLIW mode.

The reconfigurable processor may further include that the processor further includes a third CGA mode based on FUs that are different from the predetermined ones of the FUs of the second FU group.

In another general aspect, there is provided a code conversion apparatus of a reconfigurable processor, the reconfigurable processor including a processor including functional units (FUs) and execution modes, the execution modes comprising a Very Long Instruction Word (VLIW) mode based on a first FU group, a first Coarse-Grained Array (CGA) mode based on FUs of a second FU group, and a second CGA mode based on predetermined ones of the FUs of the second FU group, the code conversion apparatus including a hardware information provider configured to selectively provide hardware information selected from the group consisting of VLIW hardware information, first CGA hardware information, and second CGA hardware information, the VLIW hardware information including information about the first FU group, the first CGA hardware information including information about the FUs of the second FU group, the second CGA hardware information including information about the predetermined ones of the FUs of the second FU group, and a compiling unit configured to compile a code according to the selectively provided hardware information.

The code conversion apparatus may further include that the hardware information is selectively provided according to a characteristic of the code or a user's instruction.

The code conversion apparatus may further include that the compiling unit does not map instructions or data related to remaining FUs except for the predetermined ones of the FUs of the second FU group, based on the selectively provided hardware information.

In yet another general aspect, there is provided a code conversion method of a reconfigurable processor, the reconfigurable processor including a processor including functional units (FUs) and execution modes, the execution modes comprising a Very Long Instruction Word (VLIW) mode based on a first FU group, a first Coarse-Grained Array (CGA) mode based on FUs of a second FU group, and a second CGA mode based on predetermined ones of the FUs of the second FU group, the code conversion method including selectively providing hardware information selected from the group consisting of VLIW hardware information, first CGA hardware information, and second CGA hardware information, the VLIW hardware information including information about the first FU group, the first CGA hardware information including information about the FUs of the second FU group, the second CGA hardware information including information about the predetermined ones of the FUs of the second FU group, and compiling a code according to the selectively provided hardware information.

The code conversion method may further include that the selective providing of the hardware information is according to a characteristic of a code or a user's instruction.

The code conversion method may further include that the compiled code does not include mapped instructions or data related to remaining FUs except for the predetermined ones of the FUs of the second FU group, based on the selectively provided hardware information.

Other features and aspects will be apparent from the following detailed description, the drawings, and the claims.

### BRIEF DESCRIPTION OF THE DRAWINGS

FIG. 1 is a diagram illustrating an example of a reconfigurable processor.

FIG. 2 is a diagram illustrating an example of a configuration memory.

FIG. 3 is a diagram illustrating an example of a configuration of a decoder.

FIG. 4 is a flowchart illustrating an example of a mode conversion method of a reconfigurable processor.

FIG. 5 is a flowchart illustrating another example of a mode conversion method of a reconfigurable processor.

FIG. 6 is a view illustrating an example that explains a method for mode conversion between a first Coarse-Grained Array (CGA) mode and a second CGA mode.

FIG. 7 is a diagram illustrating an example of a code conversion apparatus of the reconfigurable processor.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

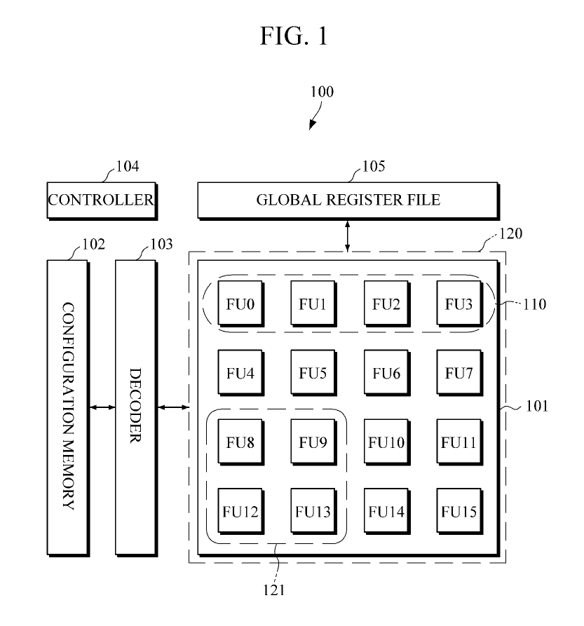

FIG. 1 is a diagram illustrating an example of a reconfigurable processor 100. Referring to the example illustrated in FIG. 1, the reconfigurable processor 100 includes a processor 101, a configuration memory 102, and a decoder 103. In an example, the reconfigurable processor 100 further includes a controller 104 and a global register file (GRF) 105.

The processor 101 includes functional units (hereinafter, referred to as FUs). In an example, each FU includes a processing element (PE) configured to perform various arithmetic or logical operations and a local register file (LRF) configured to store the results of the operations and other information. An amount of the FUs included in the processor 101 is not limited and depends on a purpose of a particular application.

The processor 101 has two execution modes: a Very Long Instruction Word (VLIW) mode and a Coarse-Grained Array (CGA) mode. In the VLIW mode, the processor 101 executes operations based on a first FU group 110. In an example, in the VLIW mode, a VLIW instruction stored in the configuration memory 102 or in a separate VLIW memory (not shown) is transferred to FU0 through FU3, which belong to the first FU group 110. In this example, the individual FU0 through FU3 executes the VLIW instruction.

In the CGA mode, the processor 101 performs operations based on a second FU group 120. In an example, in the CGA mode, a CGA instruction stored in the configuration memory 102 is transferred to FU0 through FU15, which belong to the second FU group 120. In this example, the individual FU0 through FU15 executes the CGA instruction.

Here, the FU0 through FU3 are used in both the VLIW and CGA modes, however, it is also possible that separate FUs for the VLIW mode are configured. Also, it is possible that a separate VLIW memory for the VLIW instruction is provided. In an example, the global register file 105 temporarily stores Live-in/Live-out data upon mode conversion.

In an example, the processor 101 processes iterative operations, such as a loop in the CGA mode and another operation in the VLIW mode. For example, when a mode conversion signal is generated from the controller 104 while an Operating System (OS) is being executed in the VLIW mode, context information is stored in the global register file 106 in response to the mode conversion signal and a loop operation is executed in the CGA mode. Thereafter, when the loop operation is terminated, the process again enters the VLIW mode and the context information stored in the global register file 106 returns.

In an example, the CGA mode of the processor 101 is divided into sub CGA modes. In one example, the CGA mode includes a first CGA mode in which FUs of the second FU group 120 are used, and a second CGA mode in which predetermined ones of the FUs (for example, 121) of the second FU group 120 are used. In another example, the CGA mode further includes a third CGA mode in which different FUs from the predetermined ones of the FUs 121 of the second FU group 120 are used. Here, the FUs corresponding to the third CGA mode are either all different from the predetermined FUs 121 or include a part of the predetermined FUs 121. The first CGA mode may be referred to as a M×N mode and the second CGA mode may be referred to as a K×L mode (M×N>K×L).

In an example, the configuration memory 102 stores configuration information for each execution mode of the processor 101. In a further example, the configuration information includes information about instructions that are to be processed by the individual FUs and the connection relationship between the FUs. In other words, the hardware configuration of the processor 101 may vary according to the configuration information.

In an example, the configuration memory 102 stores first CGA configuration information for the first CGA mode and second CGA configuration information for the second CGA mode. In another example, the configuration memory 102 further stores the first CGA configuration information and the second CGA configuration information in different memory areas. In yet another example, the second CGA configuration information, which is configuration information for predetermined FUs of the second FU group 120, has a capacity that is less than a capacity of the first CGA configuration information.

In an example, the decoder 103 receives a mode conversion signal from the controller 104 and transfers configuration information of the corresponding mode, stored in the configuration memory 102, to the processor 101. For example, the decoder 103 transfers the first CGA configuration information as it is to the processor 101 in the first CGA mode, and, in the second CGA mode, converts the second CGA configuration information and transfers the converted second CGA configuration information to the processor 101.

In a further example, upon the conversion of the second CGA configuration information, the decoder 103 converts configuration information of the second CGA configuration information not mapped to the predetermined FUs 121 of the second FU group 120 into a predetermined value. In other words, in this example, when only the four predetermined FUs (that is, FU9, FU10, FU13, and FU14) 121 operate in the second CGA mode, the decoder 103 changes configuration information that is transferred to the remaining FUs to a default value. In an example, the controller 104 includes a power supply (not shown) for powering off FUs that do not operate in a current mode. In an alternative example, the power supply powers off a memory area storing the second CGA configuration information in the configuration memory 102. In another example, the reconfigurable processor 100 performs conversion between the first CGA mode and the second CGA mode through the VLIW mode.

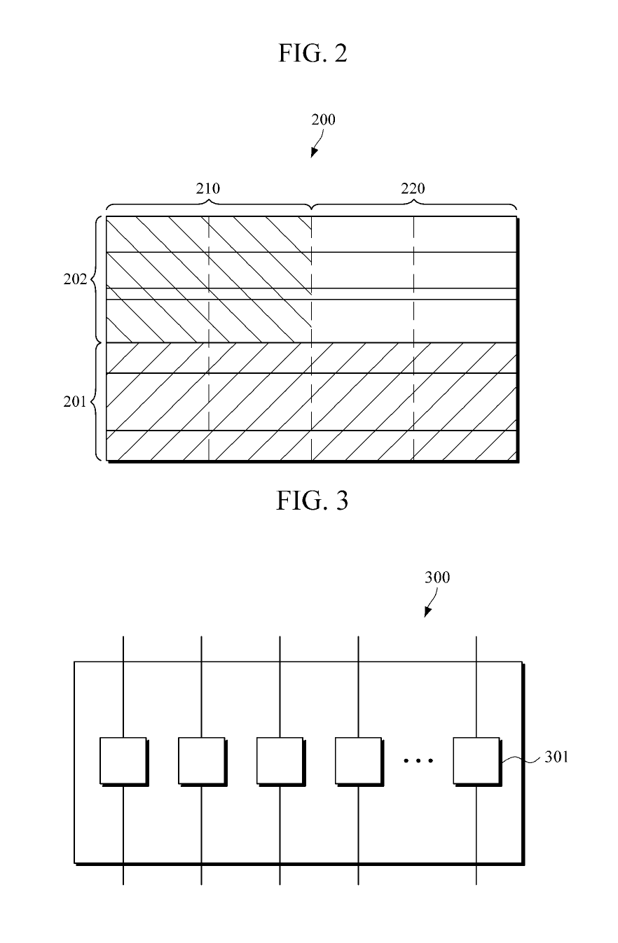

FIG. 2 is a diagram illustrating an example of a configuration memory 200. Referring to the example illustrated in FIG. 2, the configuration memory 200 includes a first area 201 and a second area 202. In an example, the first area 201 stores the first CGA configuration information, and the second area 202 stores the second CGA configuration information. As described above, it is seen that the second CGA configuration information has a capacity that is less than a capacity of the first CGA configuration information. In other words, in an example, the second CGA configuration information is divided into a valid part 210 and an invalid part 220. In this example, FUs mapped to the valid part 210 operate in the second CGA mode. In a further example, in the second CGA mode, the controller 104 of FIG. 1 powers off the invalid part 220.

FIG. 3 is a diagram illustrating an example of a configuration of a decoder 300. Referring to the example illustrated in FIG. 3, the decoder 300 includes converters 301. An input of each of the converters 301 is connected to an output of a configuration memory (for example, 102 of FIG. 1). In an example, an output of each of the converters 301 is connected to an input of a corresponding FU.

According to an aspect, the decoder 300 converts configuration of the configuration memory 102 appropriately according to a current mode. In an example, each of the converters 301 transfers the first CGA configuration information as it is to the corresponding FU, converts a part not used in the second CGA configuration information into a default value (for example, “0”), and transfers the default value to the corresponding FU.

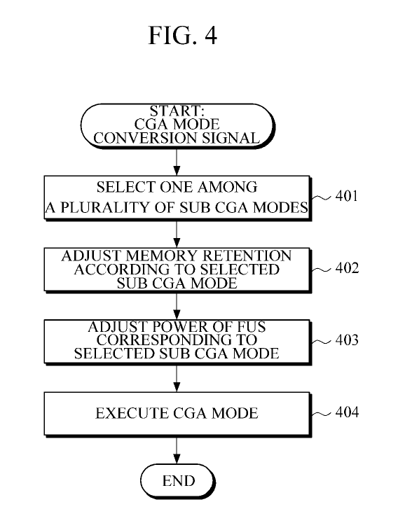

FIG. 4 is a flowchart illustrating an example of a mode conversion method of a reconfigurable processor. In an example, the mode conversion method is configured to convert the VLIW mode to the CGA mode.

Referring to the examples illustrated in FIGS. 1 and 4, one of the sub CGA modes is selected (401) in response to a CGA mode conversion signal. In an example, the first CGA mode (the M×N mode) or the second CGA mode (the K×L mode), as described above, is selected. Memory retention is adjusted (402) according to the selected sub CGA mode. For example, the configuration memory 102 is activated in response to a CGA mode conversion signal, and, if the second CGA mode is selected, a predetermined memory area is powered off (for example, 220 of FIG. 2). Successively, FUs (for example, 120 or 121) are adjusted (403) corresponding to the selected sub CGA mode being powered off. In an example, isolation cells that connect the configuration memory 102 to the corresponding FUs of the processor 101 are powered off. Then, the selected sub CGA mode is executed (404).

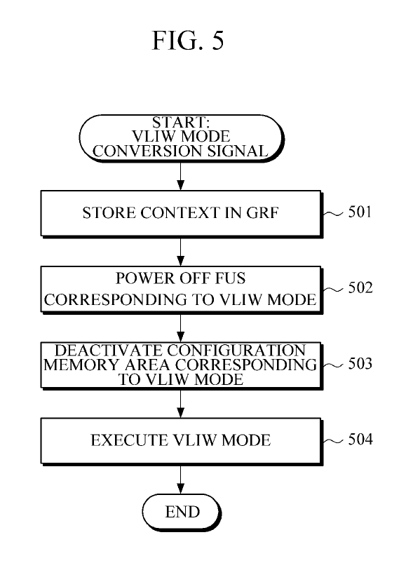

FIG. 5 is a flowchart illustrating another example of a mode conversion method of the reconfigurable processor. This example of a mode conversion method is an example for conversion from the CGA mode to the VLIW mode.

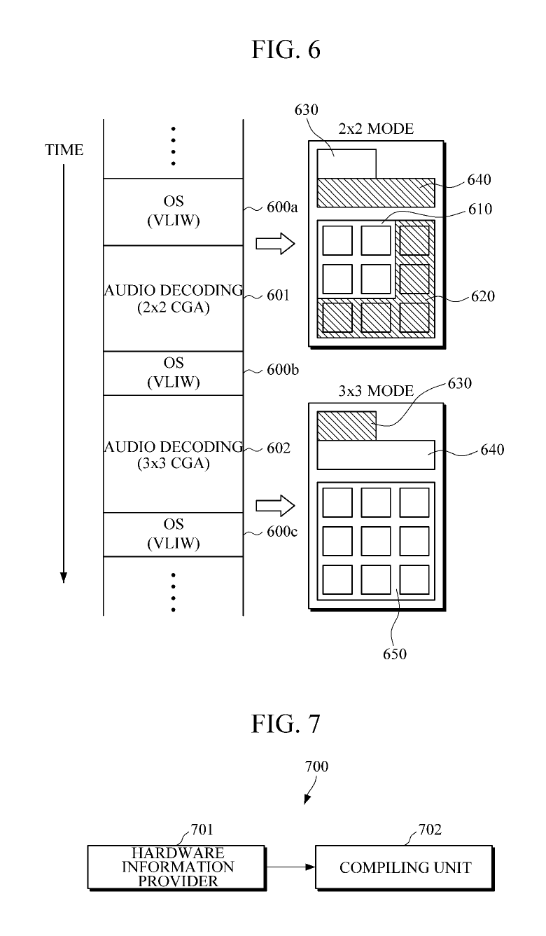

Referring to the examples illustrated in FIGS. 1 and 5, context is stored (501) in the global register file 105 in response to a VLIW mode conversion signal. In an example, the context contains an execution result of a CGA mode. Then, FUs corresponding to the VLIW mode are powered off (502). In an example, the remaining FUs except for the first FU group 110 are powered off. Successively, an area of the configuration memory 102, corresponding to the VLIW mode, is deactivated (503). In an example, if a separate VLIW memory (not shown) is provided, a VLIW instruction is fetched from the VLIW memory while retaining the configuration memory 102. Then, the VLIW mode is executed (504). FIG. 6 is a view illustrating an example that explains a method for mode conversion between a first CGA mode and a second CGA mode. Referring to the example illustrated in FIG. 6, an OS is mapped to VLIW modes 600a, 600b, and 600c, processing of audio data is mapped to a 2×2 CGA mode 601, and processing of video data is mapped to a 3×3 CGA mode 602. In the 2×2 CGA mode 601, 2×2 FUs 610 process audio data according to the second CGA configuration information 630. At this time, the remaining FUs 620 are in a deactivated state. After the processing of audio data is terminated, the process enters the VLIW mode 600b, and the 3×3 CGA mode 602 is called. In the 3×3 CGA mode 602, 3×3 FUs 650 process video data according to the first CGA configuration information 640. At this time, the second CGA configuration information 630 is in the deactivated state.

Referring to the examples illustrated in FIGS. 1 and 5, context is stored (501) in the global register file 105 in response to a VLIW mode conversion signal. In an example, the context contains an execution result of a CGA mode. Then, FUs corresponding to the VLIW mode are powered off (502). In an example, the remaining FUs except for the first FU group 110 are powered off. Successively, an area of the configuration memory 102, corresponding to the VLIW mode, is deactivated (503). In an example, if a separate VLIW memory (not shown) is provided, a VLIW instruction is fetched from the VLIW memory while retaining the configuration memory 102. Then, the VLIW mode is executed (504).

FIG. 6 is a view illustrating an example that explains a method for mode conversion between a first CGA mode and a second CGA mode. Referring to the example illustrated in FIG. 6, an OS is mapped to VLIW modes 600a, 600b, and 600c, processing of audio data is mapped to a 2×2 CGA mode 601, and processing of video data is mapped to a 3×3 CGA mode 602. In the 2×2 CGA mode 601, 2×2 FUs 610 process audio data according to the second CGA configuration information 630. At this time, the remaining FUs 620 are in a deactivated state. After the processing of audio data is terminated, the process enters the VLIW mode 600b, and the 3×3 CGA mode 602 is called. In the 3×3 CGA mode 602, 3×3 FUs 650 process video data according to the first CGA configuration information 640. At this time, the second CGA configuration information 630 is in the deactivated state.

FIG. 7 is a diagram illustrating an example of a code conversion apparatus 700 of the reconfigurable processor. The code conversion apparatus 700 is an example of a compiler included in the reconfigurable processor 100 of FIG. 1.

Referring to the examples illustrated in FIGS. 1 and 7, the code conversion apparatus 700 includes a hardware information provider 701 and a compiling unit 702.

The hardware information provider 701 selectively provides VLIW hardware information, first CGA hardware information, or second CGA hardware information. The VLIW hardware information includes information about the first FU group 110. The first CGA hardware information includes information about FUs of the second FU group 120. The second CGA hardware information includes information about predetermined ones of the FUs (for example, 121) of the second FU group 120. In an example, the hardware information provider 701 selects the VLIW hardware information, the first CGA hardware information, or the second CGA hardware information according to the characteristic of a code or a user's instruction.

The compiling unit 702 compiles a code according to the selectively provided hardware information. In an example, if the second CGA hardware information is selected by the hardware information provider 701, the compiling unit 702 ignores remaining FUs (that is, FU0 through FU08, FU11, FU12, FU14, and FU15) except for the predetermined ones of the FUs 121 of the second FU group 120 and performs compilation the predetermined ones of the FUs 121 of the second FU group 120. That is, in this example, the compiling unit 702 does not map instructions or data related to the remaining FUs except for the FUs 121 of the second FU group 120 according to the second CGA hardware information.

Hereinafter, an example of a code conversion method for the reconfigurable processor 100 will be described with reference to the examples illustrated in FIGS. 1 and 7. First, the hardware information provider 701 selectively provides the VLIW hardware information, the first CGA hardware information, or the second CGA hardware information according to the characteristic of a code or a user's instruction. The VLIW hardware information includes information about the first FU group 110. The first CGA hardware information includes information about FUs of the second FU group 120. The second CGA hardware information includes information about predetermined ones of the FUs (for example, 121) of the second FU group 120. Successively, the compiling unit 702 compiles a code according to the selectively provided hardware information.

The units described herein may be implemented using hardware components, such as, for example, microphones, amplifiers, band-pass filters, audio to digital convertors, and processing devices, and software components. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an OS and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors. As used herein, a processing device configured to implement a function A includes a processor programmed to run specific software. In addition, a processing device configured to implement a function A, a function B, and a function C may include configurations, such as, for example, a processor configured to implement both functions A, B, and C, a first processor configured to implement function A, and a second processor configured to implement functions B and C, a first processor to implement function A, a second processor configured to implement function B, and a third processor configured to implement function C, a first processor configured to implement function A, and a second processor configured to implement functions B and C, a first processor configured to implement functions A, B, C, and a second processor configured to implement functions A, B, and C, and so on.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums. The computer readable recording medium may include any data storage device that can store data which can be thereafter read by a computer system or processing device. Examples of the computer readable recording medium include read-only memory (ROM), random-access memory (RAM), CD-ROMs, magnetic tapes, floppy disks, optical data storage devices.

Program instructions to perform a method described herein, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable storage mediums.

In addition, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein. Further, the described unit to perform an operation or a method may be hardware, software, or some combination of hardware and software. For example, the unit may be a software package running on a computer or the computer on which that software is running.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A reconfigurable processor, comprising:
a processor comprising functional units (FUs) and execution modes, the execution modes comprising a Very Long Instruction Word (VLIW) mode based on a first FU group, a first Coarse-Grained Array (CGA) mode based on FUs of a second FU group, and a second CGA mode based on predetermined ones of the FUs of the second FU group.

2. The reconfigurable processor of claim 1, further comprising:
a configuration memory configured to store configuration information for the VLIW mode, the first CGA mode, and the second CGA mode; and
a decoder configured to receive a predetermined mode conversion signal, select/convert a piece of the configuration information stored in the configuration memory according to the predetermined mode conversion signal, and transfer the selected/converted configuration information to the processor.

3. The reconfigurable processor of claim 2, wherein the configuration memory stores first CGA configuration information for the first CGA mode and second CGA configuration information for the second CGA mode, in different memory areas.

4. The reconfigurable processor of claim 3, wherein the second CGA configuration information has a capacity that is less than a capacity of the first CGA configuration information.

5. The reconfigurable processor of claim 3, wherein the decoder is further configured to, in the first CGA mode, transfer the first CGA configuration information to the processor and, in the second CGA mode, convert the second CGA configuration information and transfer the converted CGA configuration information to the processor.

6. The reconfigurable processor of claim 5, wherein the decoder is further configured to convert configuration information of the second CGA configuration information not mapped to the predetermined ones of the FUs of the second FU group into a predetermined value.

7. The reconfigurable processor of claim 1, further comprising:
a power supply configured to power off one or more FUs that do not operate in a current mode.

8. The reconfigurable processor of claim 1, wherein mode conversion between the first CGA mode and the second CGA mode is performed through the VLIW mode.

9. The reconfigurable processor of claim 1, wherein the processor further comprises a third CGA mode based on FUs that are different from the predetermined ones of the FUs of the second FU group.

10. A code conversion apparatus of a reconfigurable processor, the reconfigurable processor comprising a processor comprising functional units (FUs) and execution modes, the execution modes comprising a Very Long Instruction Word (VLIW) mode based on a first FU group, a first Coarse-Grained Array (CGA) mode based on FUs of a second FU group, and a second CGA mode based on predetermined ones of the FUs of the second FU group, the code conversion apparatus comprising:
a hardware information provider configured to selectively provide hardware information selected from the group consisting of VLIW hardware information, first CGA hardware information, and second CGA hardware information, the VLIW hardware information comprising information about the first FU group, the first CGA hardware information comprising information about the FUs of the second FU group, the second CGA hardware information comprising information about the predetermined ones of the FUs of the second FU group; and
a compiling unit configured to compile a code according to the selectively provided hardware information.

11. The code conversion apparatus of claim 10, wherein the hardware information is selectively provided according to a characteristic of the code or a user's instruction.

12. The code conversion apparatus of claim 10, wherein the compiling unit does not map instructions or data related to remaining FUs except for the predetermined ones of the FUs of the second FU group, based on the selectively provided hardware information.

13. A code conversion method of a reconfigurable processor, the reconfigurable processor comprising a processor comprising functional units (FUs) and execution modes, the execution modes comprising a Very Long Instruction Word (VLIW) mode based on a first FU group, a first Coarse-Grained Array (CGA) mode based on FUs of a second FU group, and a second CGA mode based on predetermined ones of the FUs of the second FU group, the code conversion method comprising:
selectively providing hardware information selected from the group consisting of VLIW hardware information, first CGA hardware information, and second CGA hardware information, the VLIW hardware information comprising information about the first FU group, the first CGA hardware information comprising information about the FUs of the second FU group, the second CGA hardware information comprising information about the predetermined ones of the FUs of the second FU group; and
compiling a code according to the selectively provided hardware information.

14. The code conversion method of claim 13, wherein the selective providing of the hardware information is according to a characteristic of a code or a user's instruction.

15. The code conversion method of claim 13, wherein the compiled code does not include mapped instructions or data related to remaining FUs except for the predetermined ones of the FUs of the second FU group, based on the selectively provided hardware information.
